(19) United States
(12) Patent Application Publication
(10) Pub. No.: US 2026/0055790 A1
(43) Pub. Date: Feb. 26, 2026

(54) TAMPER-RESISTANT FASTENER-HEAD COVER

(71) Applicant: AMD Design, LLC, Wilmington, DE (US)

(72) Inventors: Peter Alexander LESCAILLE, North Bergen, NJ (US); Wojciech Marcin SERAFIN, Garfield, NJ (US)

(73) Assignee: AMD Design, LLC, Wilmington, DE (US)

(21) Appl. No.: 18/814,892

(22) Filed: Aug. 26, 2024

(51) Int. Cl. F16B 41/00

(52) U.S. Cl. CPC F16B 41/005

(57) ABSTRACT

The cover includes a first portion defining a first portion fastener-head cavity and a first portion fastener-body cavity. The cover also includes a second portion defining a second portion fastener-head cavity and a second portion fastener-body cavity. The second portion is configured to mate with the first portion such that the first portion fastener-head cavity and the second portion fastener-head cavity accommodate a head of a fastener and the first portion fastener-body cavity and the second portion fastener-body cavity accommodate at least a portion of a body of the fastener. When the second portion is mated with the first portion, the tamper-resistant fastener-head cover cannot be removed from the fastener without breaking a portion of either the first portion or the second portion. In this way, the cover is a single use item which may prevent tampering of the fastener.

### FIELD

This disclosure is directed to mitigating fastener tampering.

### BACKGROUND

Many times, there is a desire to ensure that fasteners (e.g., screws or bolts) are not tampered with (e.g., loosened or removed and reinstalled) after initial installation or after a documented procedure. For example, many servers are secured into racks using torqued screws. If such screws are loosened or removed and reinstalled without proper torque values, components may fail during shipping, installation, and/or use.

One way of preventing unintended access to fasteners is to limit the ability to rotate the fasteners. For example, some fasteners are configured to make them harder to tamper with by utilizing specialty heads that require special tools. While such fasteners may make it harder to loosen/tighten them, anyone with the right tool can rotate them.

### SUMMARY

A tamper-resistant fastener-head cover is described herein. The tamper-resistant fastener-head cover includes a first portion defining a first portion fastener-head cavity and a first portion fastener-body cavity. The tamper-resistant fastener-head cover also includes a second portion defining a second portion fastener-head cavity and a second portion fastener-body cavity. The second portion is configured to mate with the first portion such that: the first portion fastener-head cavity and the second portion fastener-head cavity accommodate a head of a fastener, the first portion fastener-body cavity and the second portion fastener-body cavity accommodate at least a portion of a body of the fastener, and the tamper-resistant fastener-head cover cannot be removed from the fastener without breaking a portion of either the first portion or the second portion.

A method of operating the tamper-resistant fastener-head cover described above is also described herein. The method includes inserting a tab of one of the first portion or the second portion through a slot of another of the first portion or the second portion and arranging the first portion and the second portion around a fastener. The first portion and the second portion may be arranged around the fastener before, during, or after inserting the tab in the slot. The method also includes rotating the first portion relative to the second portion such that an internal latch of one of the first portion or the second portion engages with an internal shelf of another of the first portion or the second portion.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1A illustrates an example environment where a tamper-resistant fastener-head cover may be used.

FIG. 1B illustrates an example tamper-resistant fastener-head cover in a staged state around an example fastener of the example environment of FIG. 1A.

FIG. 1C illustrates the example tamper-resistant fastener-head cover in an installed state on the example fastener.

FIG. 2A illustrates the example tamper-resistant fastener-head cover in a removal state on the example fastener.

FIG. 2B illustrates the example tamper-resistant fastener-head cover in a removed state from the example fastener.

FIG. 3A illustrates the example tamper-resistant fastener-head cover in an initial state around the example fastener.

FIG. 3B illustrates another view of the example tamper-resistant fastener-head cover in the initial state around the example fastener.

FIG. 4 illustrates the example tamper-resistant fastener-head cover in the staged state around the example fastener.

FIG. 5A illustrates the example tamper-resistant fastener-head cover in the installed state around the example fastener.

FIG. 5B illustrates another view of the example tamper-resistant fastener-head cover in the installed state around the example fastener.

FIG. 6 illustrates a section view of the example tamper-resistant fastener-head cover in the installed state around the example fastener.

### DETAILED DESCRIPTION

### Overview

There are many applications where it is desirable to prevent unintended tampering of fasteners once installed. Conventional means of preventing unintended access often relies on limiting an ability to rotate the fasteners (e.g., through specialty screw heads). While such fasteners may make it harder to loosen/tighten them, anyone with the right tool can rotate them. Accordingly, there is often no way to determine if the fasteners have been loosened, tightened, and/or removed/reinstalled after initial installation.

Described herein is a tamper-resistant fastener-head cover (hereinafter referred to simply as “cover”). The cover includes a first portion defining a first portion fastener-head cavity and a first portion fastener-body cavity. The cover also includes a second portion defining a second portion fastener-head cavity and a second portion fastener-body cavity. The second portion is configured to mate with the first portion such that the first portion fastener-head cavity and the second portion fastener-head cavity accommodate a head of a fastener and the first portion fastener-body cavity and the second portion fastener-body cavity accommodate at least a portion of a body of the fastener. When the second portion is mated with the first portion, the tamper-resistant fastener-head cover cannot be removed from the fastener without breaking a portion of either the first portion or the second portion.

As such, the cover is a single use item. That is, once it is installed, the only way to access the fastener is to break the cover, which renders the cover unusable. Control of access to replacement/extra covers can enable enhanced quality assurance by ensuring that any subsequent cover use is well documented.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

### Example Environment

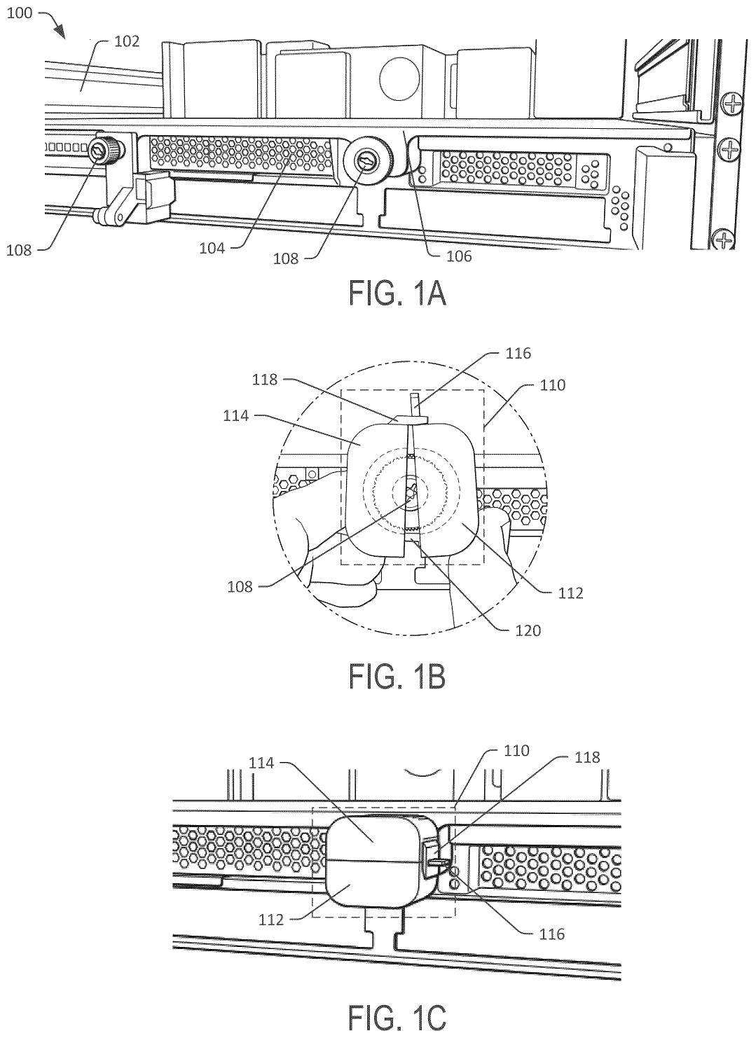

FIG. 1A illustrates an example environment 100 where a tamper-resistant fastener-head cover may be used. The example environment 100 includes a server rack 102 with a server 104 mounted therein. Between two sides of the server rack 102 is a crossmember 106. The server 104 is at least partially secured to the server rack 102 via the crossmember 106. In order to do so, fasteners 108 are used to secure the server 104 to the crossmember 106.

The fasteners 108 may be any size or shape. Furthermore, multiple sizes/configurations of the fasteners 108 may be used to secure the server 104 to the crossmember 106 and/or the server rack 102. It should be noted that the tamper-resistant fastener-head may be configurable for different size fastener heads and/or fastener shafts. One configuration may work for various sized hardware, however.

In the illustrated example, the two fasteners 108 are shoulder thumbscrews (e.g., have heads configured to be turned by hands of a user with standoffs or “shoulders” under the heads). Generally, the tamper-resistant fastener-head cover is configured to work on fasteners with shoulders (or normal fasteners with standoffs or spacers) to enable the tamper-resistant fastener-head cover to extend underneath the heads of the fasteners 108 such that it cannot be pulled off.

### Example Installation

FIG. 1B illustrates a tamper-resistant fastener-head cover 110 in a staged state around one of the fasteners 108. As discussed above, the tamper-resistant fastener-head cover 110 may be adapted for use with multiple sized and configured hardware. Accordingly, the fastener 108 in FIG. 1B may be either of the fasteners 108 in FIG. 1A.

The tamper-resistant fastener-head cover 110 consists of two portions (e.g., a first portion 112 and a second portion 114) that are configured to attach to each other around the fastener 108. In the staged state, a tab 116 on the first portion 112 extends through a slot in a tab receiver 118 on the second portion 114. A portion of the tab receiver 118 may rest against the first portion 112 in the staged state.

An internal latch 120 (which may be disposed on either the first portion 112 or the second portion 114) may rest against an internal shelf (not shown) on another of the first portion 112 or the second portion 114 in the staged state. The internal latch 120 may also be offset from the internal shelf in the staged state.

To get to the staged state, the tab 116 may be inserted through the slot of the tab receiver 118 and the first portion 112 rotated relative to the second portion 114 to fit around a head of the fastener 108. The first portion 112 may then be rotated back towards the second portion 114 to close a gap around the fastener 108 such that internal latch 120 is ready to engage with the internal shelf.

FIG. 1C illustrates the tamper-resistant fastener-head cover 110 in an installed state around the fastener 108 (occluded from view). From the staged state, the first portion 112 is rotated towards the second portion 114 such that the internal latch 120 engages the internal shelf (the tab 116 still interfaces with the tab receiver 118 from the staged state). The internal latch 120 may partially deform between the staged state and the installed state.

In the installed state, the tab 116/tab receiver 118 prevents a first side of the tamper-resistant fastener-head cover 110 from separating (e.g., a right side in the illustrated example). Furthermore, the tab receiver 118 may prevent the first portion 112 from sliding relative to the second portion 114 (e.g., to the right) to disengage the internal latch 120. The internal latch 120/latch shelf prevents a second side of the tamper-resistant fastener-head cover 110 from separating (e.g., a left side in the illustrated example). The internal latch 120 may also prevent a translation between the first portion 112 and the second portion 114 (e.g., to the left) to disengage the tab 116 from the tab receiver 118. In general, when in the installed state, the first portion 112 is unable to move in any significant fashion (tolerances will enable slight movement) relative to the second portion 114.

The internal latch 120 may not be releasable from the internal shelf in the installed state (e.g., due to complete occlusion by the tamper-resistant fastener-head cover 110 and the fastener 108. Accordingly, once the internal latch 120 is engaged, the first portion 112 may not be separated from the second portion 114 (and thus too the tamper-resistant fastener-head cover 110 removed from the fastener 108) unless the tab 116 is broken off first.

### Example Removal

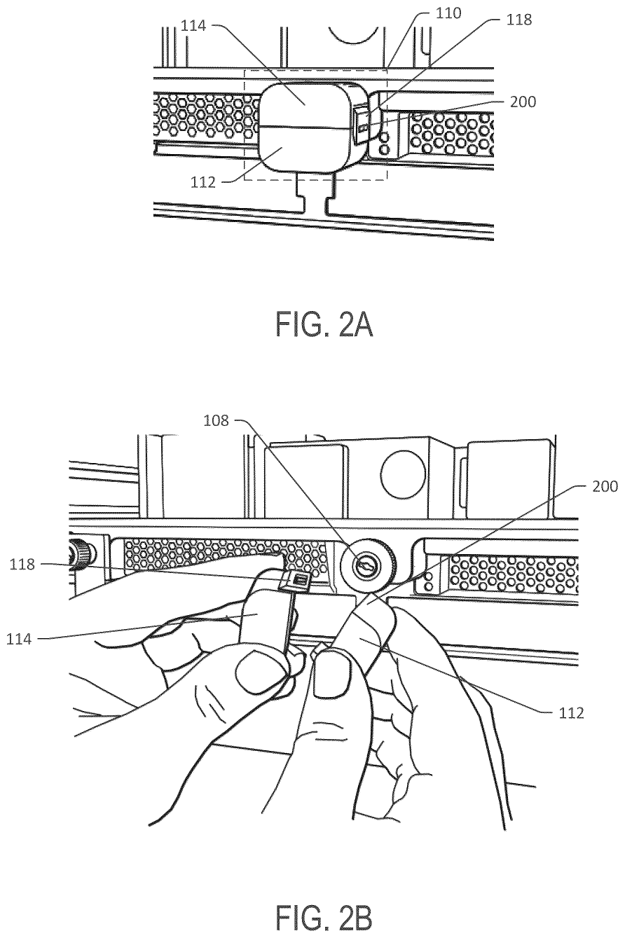

FIG. 2A illustrates the tamper-resistant fastener-head cover 110 in a removal state around the fastener 108. The removal state is similar to the installed state, except that the tab 116 has been broken off/removed from a body of the first portion 112.

The tab 116 may be configured to break near an end of the tab 116 (e.g., towards the body of the first portion 112) when a sufficient bending force is applied to the tab 116. For example, the tab 116 may have a notch portion where it is attached to the body of the first portion 112. The notch portion may be configured to cause a stress concentration such that the bending force will cause the tab 116 to break there as opposed to any other location along the tab 116.

FIG. 2B illustrates the tamper-resistant fastener-head cover 110 in a removed state from the fastener. To get from the removal state to the removed state, the second portion 114 is first rotated relative to the first portion 112, which allows the first portion 112 to be separated from the second portion 114.

With the tab 116 broken off, the tab receiver 118 can slide over an area 200 where the tab 116 was attached. As such, the second portion 114 can be rotated relative to the first portion 112. The internal latch/shelf may prevent the portions from being linearly separated (e.g., pulled apart). Once the second portion 114 is rotated from the first portion 112, the internal latch may disengage from the internal shelf, which allows the first portion 112 and the second portion to be separated. In some implementations, a slight translation of the portion that has the internal latch may be required to allow the portions to fully separate (e.g., to clear the shelf).

### Example Tamper-Resistant Fastener-Head Cover

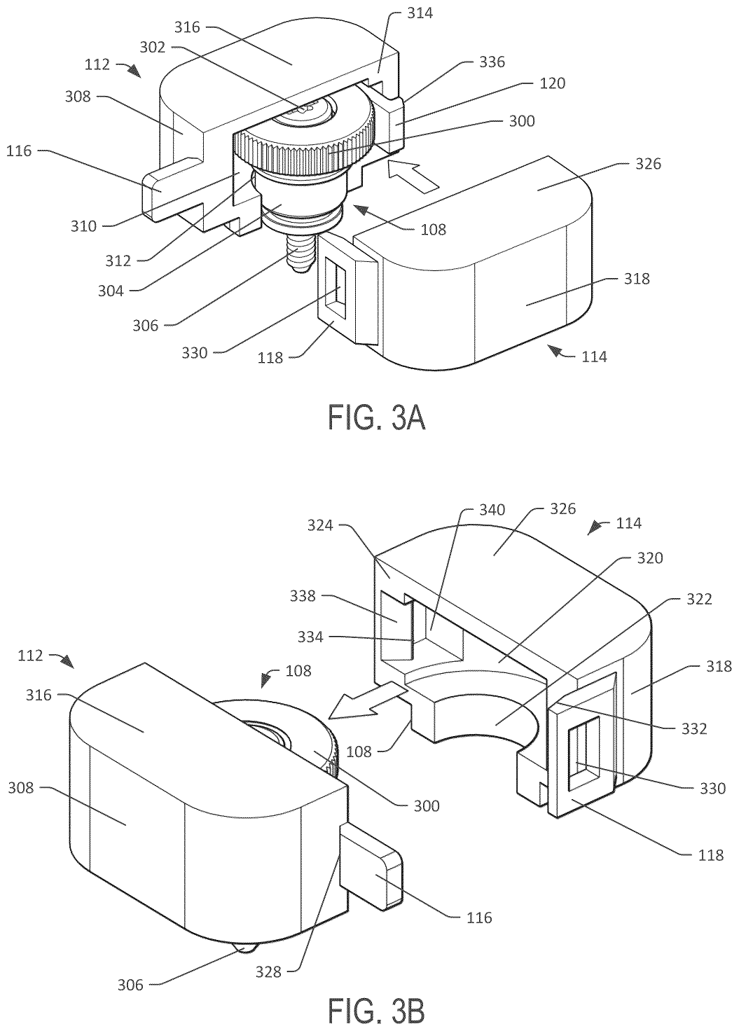

FIGS. 3A and 3B illustrate an example of the tamper-resistant fastener-head cover 110 and an example of the fastener 108 from different views. The tamper-resistant fastener-head cover 110 is illustrated in an open or initial state (e.g., the first portion 112 and the second portion 114 are not mated and the tab 116 is not inserted within the tab receiver). The fastener 108 is shown for reference. As discussed above, the tamper-resistant fastener-head cover 110 includes the first portion 112 and the second portion 114 configured to attach together around the fastener 108.

The fastener 108 includes a fastener head 300 which may be knurled (e.g., a thumbscrew) or may be configured to interface with a socket (e.g., hex head, Torx head, square head, any number of points/shape head). The fastener head 300 may also have a fastener head driver portion 302 (e.g., a portion configured to receive a driver or bit). The fastener 108 also includes a fastener body 304. The fastener body 304 may be cylindrical (e.g., a shoulder or standoff) or any other shape. A diameter/largest dimension of the fastener head 300 may be larger than a diameter/largest dimension of the fastener body 304. Below the fastener body 304 may be fastener threads 306. The fastener threads 306 may be any type of thread and generally have a smaller diameter than that of the fastener body 304. Thus, if the fastener 108 is configured as a shoulder screw/bolt, the fastener head 300 has a diameter larger than that of the fastener body 304, which has a diameter larger than that of the fastener threads 306. In the illustrated example, the fastener 108 is a shoulder thumbscrew with a fastener head driver portion 302.

The first portion 112 has a first portion body 308 that forms a first portion fastener head cavity 310 and a first portion fastener body cavity 312 that are in communication with each other. In other words, the first portion fastener head cavity 310 and the first portion fastener body cavity 312 are respective portions of a single cavity formed within the first portion 112. The first portion fastener head cavity 310 may extend from a first portion mating surface 314. The first portion mating surface 314 may be planar (as illustrated) or non-planar. The first portion fastener head cavity 310 may be hemi-cylindrical (e.g., half of a cylinder) and may be configured to accommodate the fastener head 300. To do so, the first portion fastener head cavity 310 may include a first dimension (e.g., diameter) that is larger than a largest dimension (e.g., diameter) of the fastener head 300 and a second dimension (e.g., depth) that is larger than a depth of the fastener head 300. The first portion fastener head cavity 310 may not extend to a first portion top surface 316.

The first portion fastener body cavity 312 may also extend from the first portion mating surface 314. The first portion fastener body cavity 312 may be hemi-cylindrical and may be configured to accommodate the fastener body 304. To do so, the first portion fastener body cavity 312 may include a first dimension (e.g., diameter) that is larger than a largest dimension (e.g., diameter) of the fastener body 304 and a second dimension (e.g., depth) that is smaller than a depth of the fastener body 304. The first portion fastener body cavity 312 extends to a first portion bottom surface that is opposite the first portion top surface 316.

The second portion 114 has a second portion body 318 that forms a second portion fastener head cavity 320 and a second portion fastener body cavity 322 that are in communication with each other. In other words, the second portion fastener head cavity 320 and the second portion fastener body cavity 322 are respective portions of a single cavity formed within the second portion 114. The second portion fastener head cavity 320 may extend from a second portion mating surface 324. The second portion mating surface 324 may be planar (as illustrated) or non-planar. Regardless of surface profile, the second portion mating surface 324 may be configured to interface with the first portion mating surface 314. The second portion fastener head cavity 320 may be hemi-cylindrical and may also be configured to accommodate the fastener head 300. To do so, the second portion fastener head cavity 320 may include a first dimension (e.g., diameter) that is larger than a largest dimension (e.g., diameter) of the fastener head 300 and a second dimension (e.g., depth) that is larger than a depth of the fastener head 300. The second portion fastener head cavity 320 may not extend to a second portion top surface 326.

The second portion fastener body cavity 322 may also extend from the second portion mating surface 324. The second portion fastener body cavity 322 may be hemi-cylindrical and may be configured to accommodate the fastener body 304. To do so, the second portion fastener body cavity 322 may include a first dimension (e.g., diameter) that is larger than a largest dimension (e.g., diameter) of the fastener body 304 and a second dimension (e.g., depth) that is smaller than a depth of the fastener body 304. The second portion fastener body cavity 322 extends to a second portion bottom surface that is opposite the second portion top surface 326.

Extending perpendicular to the first portion mating surface 314 from the first portion body 308 is the tab 116. The tab 116 may have a rectangular cross section and extend far enough away from the first portion body 308 to enable it to engage with the tab receiver 118 and still have enough length past the tab receiver 118 to be manipulated (e.g., bent/broken) by a user. The rectangular cross section may have one dimension that is much larger than another. In this way, a “pushing surface” (e.g., a wider surface) may be more obvious to a user.

The tab 116 attaches to the first portion body 308 via a break-off portion 328. The break-off portion 328 may comprise a notch or other structure configured to cause a stress concentration at the break-off portion 328, such that the tab 116 breaks at the break-off portion 328 (e.g., at the intersection of the first portion body 308) when an adequate force to one of the “pushing surfaces” is provided. The break-off portion 328 may be on any side of the tab 116 and one side of the tab 116 may be flush with the first portion mating surface 314. The tab 116 may be rotated/moved relative to the first portion body 308 and vary in shape and size without departing from the scope of this disclosure.

The tab receiver 118 attaches to the second portion body 318 and extends away from the second portion body 318 and past the second portion mating surface 324. By having the tab receiver 118 extend past the second portion mating surface 324, the tab receiver 118 can engage with the tab 116 and prevent the first portion 112 from translating past the tab receiver 118 in the staged state. The tab receiver 118 has a slot 330 that is at least slightly larger than a cross section of the tab 116 (e.g., to enable the tab 116 to slide therethrough) and shorter than a length of the tab 116 (to enable a breaking force to be applied to the tab 116 to separate the first portion 112 from the second portion 114). The slot 330 may extend perpendicular to a cylindrical axis of the second portion fastener head cavity 320 and/or perpendicular to a normal axis of the first portion mating surface 314. The tab receiver 118 may also have a tab receiver chamfer 332. The tab receiver chamfer may enable the tab receiver to more easily be used to separate the second portion 114 from the first portion 112 once the tab 116 has been removed (e.g., going from the removal state to the removed state).

In the illustrated example, the first portion 112 has the internal latch 120 and the second portion 114 has an internal shelf 334. In some embodiments, the first portion 112 may have the internal shelf 334 and the second portion 114 may have the internal latch 120. The internal latch 120 and the internal shelf 334 are configured to work in conjunction to secure the first portion 112 to the second portion 114.

The internal latch 120 may extend from the first portion mating surface 314 and may communicate with the first portion fastener head cavity 310. The internal latch 120 may be configured/oriented to bend towards the tab 116 (e.g., via an internal latch lead in chamfer 336 hitting the internal shelf 334) when the first portion 112 and the second portion 114 are mated (e.g., going from the staged state to the installed state). The illustrated orientation may enable the internal latch 120 to more easily disengage from the internal shelf 334 during removal (e.g., the rotation of the first portion 112 relative to the second portion 114 after the tab 116 easily allows the internal latch 120 to rotate relative to the internal shelf 334). The internal latch 120 may be rotated relative to the first portion body 308; however.

To facilitate the bending/engagement of the internal latch 120, the internal shelf 334 may have an internal shelf lead in chamfer 338. The internal shelf lead in chamfer 338 may work in conjunction with the internal latch lead in chamfer 336 to cause the internal latch 120 to temporarily bend/deform upon mating of the first portion 112 and the second portion 114. When it returns, an underside of the internal latch 120 may be parallel to and behind the internal shelf 334.

It should be noted that the internal shelf 334 is formed within an internal shelf cavity 340. The internal shelf cavity 340 is configured to allow the internal latch to engage with the internal shelf 334 and deform during mating of the first portion 112 and the second portion 114 as well as return to place the underside of the internal latch 120 behind the internal shelf. The internal shelf cavity 340 may communicate with the second portion fastener head cavity 320 (e.g., for ease of manufacturing) and may be occluded when the first portion 112 and the second portion 114 are mated. Doing so ensures that the internal latch 120 is inaccessible and, thus, cannot be disengaged from the internal shelf 334 in the installed state. It should be noted that the internal shelf cavity 340, the second portion fastener head cavity 320, and the second portion fastener body cavity 322 may all be portions of a single cavity.

It should be apparent that the first portion 112 and the second portion 114 may be formed as single parts. For example, the first portion 112 and the second portion 114 may be injection molded or printed. Furthermore, the first portion 112 and the second portion 114 may be formed of plastic, metal, or any other material.

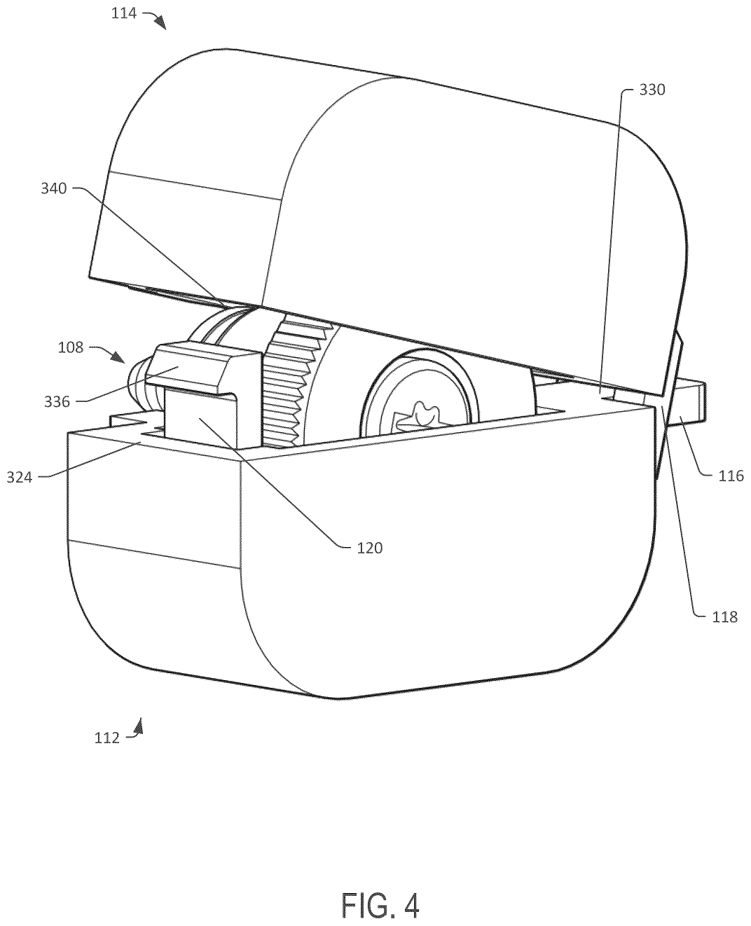

FIG. 4 illustrates the tamper-resistant fastener-head cover 110 in the staged state. As discussed above the tab 116 has been inserted through the slot 330 of the tab receiver 118 and the first portion 112 and the second portion 114 are surrounding the fastener 108. The first portion fastener head cavity 310 and the second portion fastener head cavity 320 surround the fastener head 300, and the first portion fastener body cavity 312 and the second portion fastener body cavity 322 surround the fastener body 304.

In the staged state, the tab receiver 118 may rest against the first portion 112. Doing so may locate the internal latch 120 relative to the internal shelf 334 (occluded). It may also locate a first edge on the first portion 112 to a second edge on the second portion 114 (e.g., edges of the respective mating surfaces proximate the tab 116 and tab receiver 118). In other words, the staged state may restrict one side of the tamper-resistant fastener-head cover 110 such that the first portion 112 and the second portion 114 can only rotate and/or slightly translate around a rotation axis proximate an intersection of the tab 116 and tab receiver 118.

To go from the staged state to the installed state, a relative rotation of the first portion 112 and the second portion 114 (e.g., along an imaginary axis proximate where the tab 116 interfaces with the slot 330) causes the internal latch 120 (e.g., the internal latch lead in chamfer 336, if implemented) to engage with the internal shelf 334 (e.g., the internal shelf lead in chamfer 338, if implemented) causing the internal latch 120 to temporarily deform and engage with the internal shelf 334. It should be noted that one or both of the internal latch 120 and the internal shelf 334 may have a lead-in chamfer.

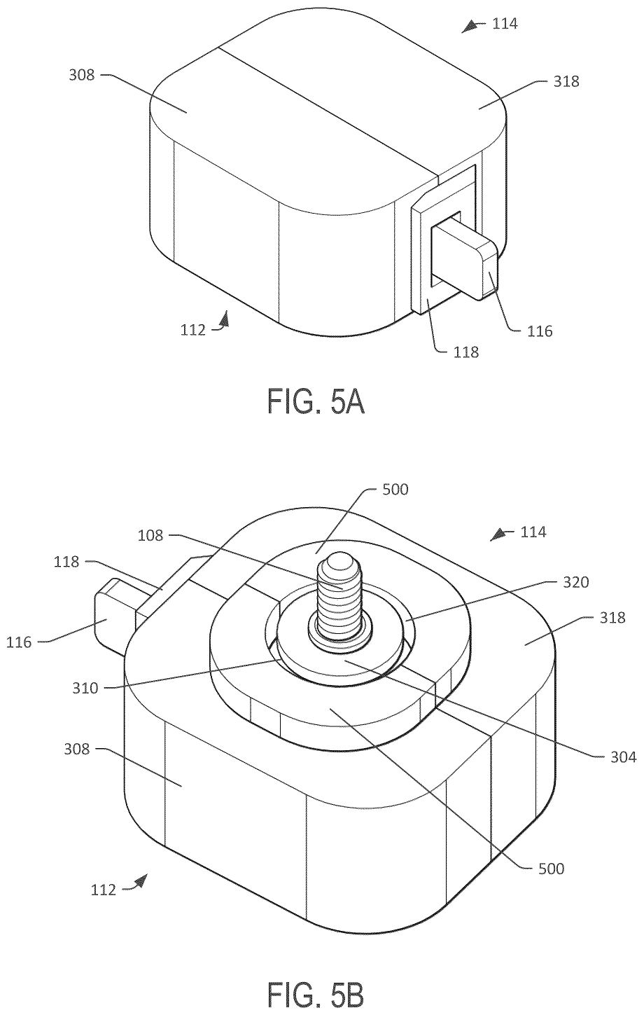

FIGS. 5A and 5B illustrate the tamper-resistant fastener-head cover 110 in the installed state around the fastener 108 from different views. In the installed state, the first portion 112 and the second portion 114 are mated together (e.g., the tab 116 is mated with the tab receiver 118 and the internal latch 120 is mated with the internal shelf 334). In the installed state, the first portion 112 and the second portion 114 cannot be separated without rendering the tamper-resistant fastener-head cover 110 in operable.

When mated, the first portion body 308 and the second portion body 318 form a combined body. The combined body may form a square shape (as illustrated), a round shape (e.g., a cylinder), or any other shape. Similarly, the first portion fastener cavities (the first portion fastener head cavity 310 and the first portion fastener body cavity 312) communicate with the second portion fastener cavities (the second portion fastener head cavity 320 and the second portion fastener body cavity 322) to form combined cavities that may be cylindrical, square, any other shape, or some combination thereof. In the illustrated example, the combined cavities are cylindrical.

As can be seen in FIG. 5B, the combined fastener body cavity (formed of the first portion fastener body cavity 312 and the second portion fastener body cavity 322) has a diameter (or other smallest dimension) that is larger than the fastener body 304. In the illustrated example, portions of the bodies that surround the combined fastener body cavity form an elevated surface 500. The elevated surface 500 may allow for clearance around objects proximate the fastener 108 in an installation location.

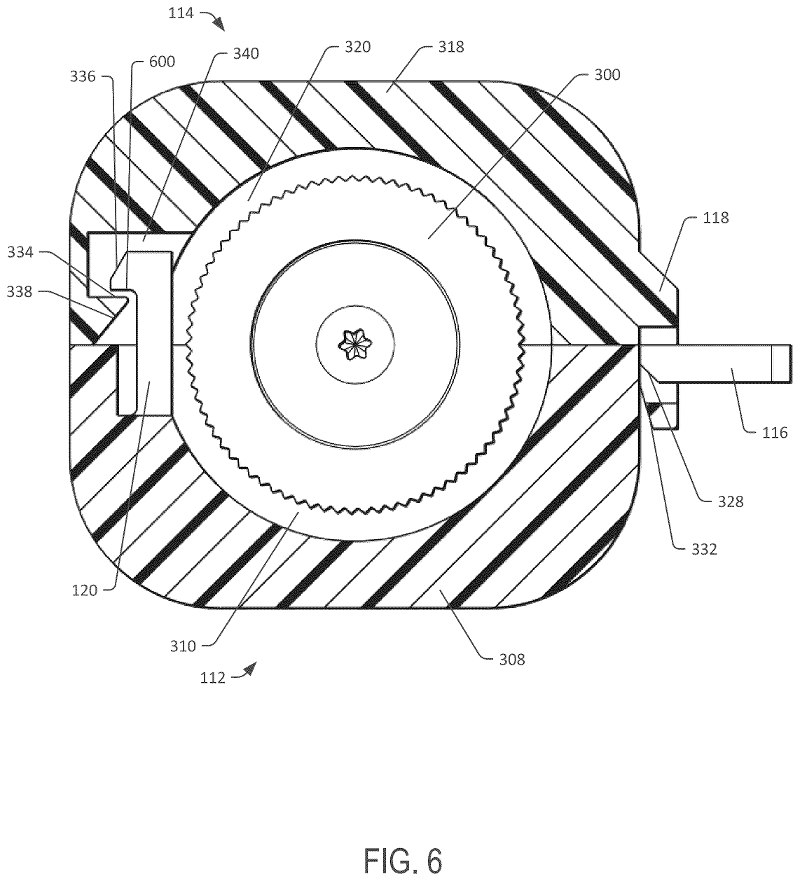

FIG. 6 illustrates a section view of the tamper-resistant fastener-head cover 110 in the installed state around the fastener 108. The section is through the combined fastener-head cavity, above the fastener head 300, and looking towards the fastener threads 306.

As can be seen, the combined fastener head cavity (formed of the first portion fastener head cavity 310 and the second portion fastener head cavity 320) has a diameter (or other smallest dimension) that is larger than the fastener head 300. In combination with the combined fastener body cavity being larger than the fastener body 304, the tamper-resistant fastener-head cover 110 is able to rotate relative to the fastener 108 without rotating the fastener 108.

In the installed state, the internal latch 120 has a portion (e.g., latching surface 600) that is behind the internal shelf 334 when viewed from the first portion 112. Doing so prevents the latch side (e.g., the left side in the illustrated example) of the first portion 112 and the second portion 114 from separating. A body of the internal latch 120, in combination with the tab receiver 118 resting against the first portion body 308, may prevent a translation between the first portion 112 and the second portion 114 along the mating surfaces. The tab 116 interfacing with the tab receiver 118 prevents the tab side (e.g., the right side in the illustrated example) of the first portion 112 and the second portion 114 from separating. Accordingly, the tamper-resistant fastener-head cover 110 cannot be removed from the fastener 108 without first moving to the removal state (e.g., removing the tab 116 from the first portion body 308. Doing so enables the tab side to be separated, which enables a relative rotation between the first portion 112 and the second portion 114 (e.g., along an axis proximate a left extent of the mating surfaces in the illustrated example), which disengages the internal latch 120 from the internal shelf 334 and allows the first portion 112 and the second portion 114 to be separated.

### EXAMPLES

Example 1: A tamper-resistant fastener-head cover comprising: a first portion defining a first portion fastener-head cavity and a first portion fastener-body cavity; a second portion defining a second portion fastener-head cavity and a second portion fastener-body cavity, wherein the second portion is configured to mate with the first portion such that: the first portion fastener-head cavity and the second portion fastener-head cavity accommodate a head of a fastener; the first portion fastener-body cavity and the second portion fastener-body cavity accommodate at least a portion of a body of the fastener; and the tamper-resistant fastener-head cover cannot be removed from the fastener without breaking a portion of either the first portion or the second portion.

Example 2: The tamper-resistant fastener-head cover of example 1, wherein the second portion is configured to mate with the first portion such that the tamper-resistant fastener-head cover can rotate around the fastener without rotating the fastener.

Example 3: The tamper-resistant fastener-head cover of example 1 or 2, wherein: the first portion or the second portion includes a tab; another of the first portion or the second portion that does not include the tab includes a tab receiver configured to interface with the tab; the first portion or the second portion includes an internal latch; and another of the first portion or the second portion that does not include the internal latch includes an internal shelf configured to interface with the internal latch.

Example 4: The tamper-resistant fastener-head cover of example 3, wherein the tab and the tab receiver are configured to not allow the first portion to rotate relative to the second portion when mated.

Example 5: The tamper-resistant fastener-head cover of example 3 or 4, wherein the internal latch and the internal shelf are configured to be inaccessible when the first portion is mated to the second portion.

Example 6: The tamper-resistant fastener-head cover of any of examples 3-5, wherein the second portion is configured to mate with the first portion by first interfacing the tab with the tab receiver and then interfacing the internal latch with the internal shelf.

Example 7: The tamper-resistant fastener-head cover of examples 3-6, wherein the tab receiver includes a slot configured to receive the tab.

Example 8: The tamper-resistant fastener-head cover of example 7, wherein: the first portion includes a first portion mating surface and the second portion includes a second portion mating surface; the first portion mating surface and the second portion mating surface are planar; and the slot extends orthogonal to the first portion mating surface or the second portion mating surface.

Example 9: The tamper-resistant fastener-head cover of example 7 or 8, wherein the slot extends orthogonal to a cylindrical axis of the first portion fastener-head cavity, the first portion fastener-body cavity, the second portion fastener-head cavity, or the second portion fastener-body cavity.

Example 10: The tamper-resistant fastener-head cover of any of examples 3-9, wherein: the portion is the tab; and responsive to breaking off the tab, the second portion can rotate relative to the first portion.

Example 11: The tamper-resistant fastener-head cover of any of examples 3-10, wherein the internal latch includes a lead in chamfer configured to interface with the internal shelf to cause the internal latch to temporarily deform when the first portion is mated to the second portion.

Example 12: The tamper-resistant fastener-head cover of example 11, wherein: the first portion includes a first portion mating surface and the second portion includes a second portion mating surface; the first portion mating surface and the second portion mating surface are planar; and the internal latch is configured to deform along a direction parallel to the first portion mating surface or the second portion mating surface.

Example 13: The tamper-resistant fastener-head cover of any of examples 3-12, wherein: the first portion includes a first portion mating surface and the second portion includes a second portion mating surface; and the internal latch extends from the first portion mating surface or the second portion mating surface away from the first portion fastener-head cavity and the second portion fastener-body cavity or the second portion fastener-head cavity and the second portion fastener-body cavity.

Example 14: The tamper-resistant fastener-head cover of any of examples 3-13, wherein the internal shelf is formed within an internal shelf cavity that is in communication with the first portion fastener-head cavity or the second portion fastener-head cavity.

Example 15: The tamper-resistant fastener-head cover of any previous example, wherein: the first portion fastener-head cavity communicates with the first portion fastener-body cavity; and the second portion fastener-head cavity communicates with the second portion fastener-body cavity.

Example 16: The tamper-resistant fastener-head cover of any previous example, wherein: the first portion fastener-head cavity does not communicate with a first portion top surface of the first portion; and the second portion fastener-head cavity does not communicate with a second portion top surface of the second portion.

Example 17: The tamper-resistant fastener-head cover of any previous example, wherein the first portion fastener-head cavity, the first portion fastener-body cavity, the second portion fastener-head cavity, and the second portion fastener-body cavity are substantially hemi-cylindrical.

Example 18: The tamper-resistant fastener-head cover of example 17, wherein: the head of the fastener has a largest cross-sectional dimension; and a diameter of each of the first portion fastener-head cavity and the second portion fastener-head cavity is larger than the largest cross-sectional dimension.

Example 19: The tamper-resistant fastener-head cover of example 18, wherein: the body of the fastener has a diameter; and a diameter of each of the first portion fastener-body cavity and the second portion fastener-body cavity is larger than the diameter of the body of the fastener but smaller than the diameter of each of the first portion fastener-head cavity and the second portion fastener-head cavity.

Example 20: The tamper-resistant fastener-head cover of any preceding example, wherein the fastener is a shoulder screw or a shoulder bolt.

Example 21: A method of interfacing a tamper-resistant fastener-head cover with a fastener, the method comprising: performing one of: a first process including: disposing a first portion defining a first portion fastener-head cavity and a first portion fastener-body cavity and a second portion defining a second portion fastener-head cavity and a second portion fastener-body cavity around the fastener such that the first portion fastener-head cavity and the second portion fastener-head cavity at least partially surround a head of the fastener and the first portion fastener-body cavity and the second portion fastener-body cavity at least partially surround a body of the fastener; inserting a tab of one of the first portion or the second portion into a tab receiver of another of the first portion or the second portion; and rotating the first portion relative to the second portion towards each other effective to cause an internal latch of the first portion or the second portion to engage with an internal shelf of another of the first portion or the second portion; or a second process including: inserting the tab into the tab receiver; disposing the first portion and the second portion, with the tab inserted into the tab receiver, around the fastener such that the first portion fastener-head cavity and the second portion fastener-head cavity at least partially surround the head of the fastener and the first portion fastener-body cavity and the second portion fastener-body cavity at least partially surround the body of the fastener; and rotating the first portion relative to the second portion towards each other effective to cause the internal latch to engage with the internal shelf.

Example 22: The method of example 21, wherein rotating the first portion relative to the second portion towards each other causes access to the internal latch to be blocked by the first portion or the second portion that includes the internal shelf.

Example 23: The method of example 21 or 22, wherein the tab and tab receiver are disposed on an opposite side of the tamper-resistant fastener-head cover than the internal latch and internal shelf.

Example 24: The method of any of examples 21-23, wherein rotating the first portion relative to the second portion towards each other is around a rotation axis proximate an intersection of the tab and tab receiver.

Example 25: The method of any of examples 21-24, wherein inserting the tab into the tab receiver includes inserting the tab into the tab receiver until a body of the first portion or the second portion interfaces with the tab receiver.

Example 26: The method of any of examples 21-25, wherein the method includes: breaking the tab from the first portion or the second portion; rotating the first portion relative to the second portion away from each other; and removing the tamper-resistant fastener-head cover from the fastener.

Example 27: The method of example 26, wherein rotating the first portion relative to the second portion away from each other is effective to disengage the internal latch from the internal shelf.

Example 28: The method of example 26 or 27, wherein breaking the tab includes breaking the tab from a body of the first portion or the second portion.

Example 29: A tamper-resistant fastener-head cover comprising: a first means; and a second means for mating with the first means to: accommodate a head of a fastener and at least a portion of a body of the fastener therein; and prevent the first means and second means that are mated from being removed from the fastener without breaking a portion of either the firms means or the second means.

Example 30: A tamper-resistant fastener-head cover comprising: means for accommodating a head of a fastener such that a rotation of the tamper-resistant fastener-head cover does not rotate the fastener; means for accommodating a body of the fastener such that the tamper-resistant fastener-head cover cannot be pulled from the fastener along a length axis of the fastener; means for securing a first portion of the tamper-resistant fastener-head cover to a second portion of the tamper-resistant fastener-head cover; and means for modifying the tamper-resistant fastener-head cover to allow the first portion to rotate relative to the second portion effective to enable the first portion to be separated from the second portion.

### Conclusion

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms up, upper, down, lower, above, below, left, right, forward, rearward, and the like are intended to be understood in the context of the representations described and illustrated above so that a wearable device may have such an orientation in reference to the frame or to various elements as supported by the frame or as illustrated in the drawing figures.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description but is not intended to be exhaustive or limited to this disclosure in the form disclosed. Many modifications and variations will be apparent to those of ordinary skill in the art without departing from the scope and spirit of this disclosure. The various embodiments were chosen and described in order to best explain the principles of this disclosure and the practical application, and to enable others of ordinary skill in the art to understand this disclosure for various embodiments with various modifications as are suited to the particular use contemplated.

What is claimed is:

1. A tamper-resistant fastener-head cover comprising:
a first portion defining a first portion fastener-head cavity and a first portion fastener-body cavity; and
a second portion defining a second portion fastener-head cavity and a second portion fastener-body cavity, wherein the second portion is configured to mate with the first portion such that:
the first portion fastener-head cavity and the second portion fastener-head cavity accommodate a head of a fastener;
the first portion fastener-body cavity and the second portion fastener-body cavity accommodate at least a portion of a body of the fastener; and
the tamper-resistant fastener-head cover cannot be removed from the fastener without breaking a portion of either the first portion or the second portion.

2. The tamper-resistant fastener-head cover of claim 1, wherein the second portion is configured to mate with the first portion such that the tamper-resistant fastener-head cover can rotate around the fastener without rotating the fastener.

3. The tamper-resistant fastener-head cover of claim 1, wherein:
the first portion fastener-head cavity does not communicate with a first portion top surface of the first portion; and
the second portion fastener-head cavity does not communicate with a second portion top surface of the second portion.

4. The tamper-resistant fastener-head cover of claim 1, wherein:
the head of the fastener has a largest cross-sectional dimension;
a diameter of each of the first portion fastener-head cavity and the second portion fastener-head cavity is larger than the largest cross-sectional dimension;
the body of the fastener has a diameter; and
a diameter of each of the first portion fastener-body cavity and the second portion fastener-body cavity is larger than the diameter of the body of the fastener but smaller than the diameter of each of the first portion fastener-head cavity and the second portion fastener-head cavity.

5. The tamper-resistant fastener-head cover of claim 1, wherein:
the first portion or the second portion includes a tab;
another of the first portion or the second portion that does not include the tab includes a tab receiver configured to interface with the tab;
the first portion or the second portion includes an internal latch; and
another of the first portion or the second portion that does not include the internal latch includes an internal shelf configured to interface with the internal latch.

6. The tamper-resistant fastener-head cover of claim 5, wherein the tab and the tab receiver are configured to not allow the first portion to rotate relative to the second portion when mated.

7. The tamper-resistant fastener-head cover of claim 5, wherein the internal latch and the internal shelf are configured to be inaccessible when the first portion is mated to the second portion.

8. The tamper-resistant fastener-head cover of claim 5, wherein the second portion is configured to mate with the first portion by first interfacing the tab with the tab receiver and then interfacing the internal latch with the internal shelf.

9. The tamper-resistant fastener-head cover of claim 5, wherein the tab receiver includes a slot configured to receive the tab.

10. The tamper-resistant fastener-head cover of claim 5, wherein the internal latch includes a lead in chamfer configured to interface with the internal shelf to cause the internal latch to temporarily deform when the first portion is mated to the second portion.

11. The tamper-resistant fastener-head cover of claim 5, wherein the internal shelf is formed within an internal shelf cavity that is in communication with the first portion fastener-head cavity or the second portion fastener-head cavity.

12. A method of interfacing a tamper-resistant fastener-head cover with a fastener, the method comprising:
performing one of:
a first process including:
disposing a first portion defining a first portion fastener-head cavity and a first portion fastener-body cavity and a second portion defining a second portion fastener-head cavity and a second portion fastener-body cavity around the fastener such that the first portion fastener-head cavity and the second portion fastener-head cavity at least partially surround a head of the fastener and the first portion fastener-body cavity and the second portion fastener-body cavity at least partially surround a body of the fastener;
inserting a tab of one of the first portion or the second portion into a tab receiver of another of the first portion or the second portion; and
rotating the first portion relative to the second portion towards each other effective to cause an internal latch of the first portion or the second portion to engage with an internal shelf of another of the first portion or the second portion; or
a second process including:
inserting the tab into the tab receiver;
disposing the first portion and the second portion, with the tab inserted into the tab receiver, around the fastener such that the first portion fastener-head cavity and the second portion fastener-head cavity at least partially surround the head of the fastener and the first portion fastener-body cavity and the second portion fastener-body cavity at least partially surround the body of the fastener; and
rotating the first portion relative to the second portion towards each other effective to cause the internal latch to engage with the internal shelf.

13. The method of claim 12, wherein rotating the first portion relative to the second portion towards each other causes access to the internal latch to be blocked by the first portion or the second portion that includes the internal shelf.

14. The method of claim 12, wherein the tab and tab receiver are disposed on an opposite side of the tamper-resistant fastener-head cover than the internal latch and internal shelf.

15. The method of claim 12, wherein rotating the first portion relative to the second portion towards each other is around a rotation axis proximate an intersection of the tab and tab receiver.

16. The method of claim 12, wherein inserting the tab into the tab receiver includes inserting the tab into the tab receiver until a body of the first portion or the second portion interfaces with the tab receiver.

17. The method of claim 12, wherein the method includes:
breaking the tab from the first portion or the second portion;
rotating the first portion relative to the second portion away from each other; and
removing the tamper-resistant fastener-head cover from the fastener.

18. The method of claim 17, wherein rotating the first portion relative to the second portion away from each other is effective to disengage the internal latch from the internal shelf.

19. The method of claim 17, wherein breaking the tab includes breaking the tab from a body of the first portion or the second portion.

20. A tamper-resistant fastener-head cover comprising:
a first means; and
a second means for mating with the first means to:
accommodate a head of a fastener and at least a portion of a body of the fastener therein; and
prevent the first means and second means that are mated from being removed from the fastener without breaking a portion of either the firms means or the second means.
means for accommodating a head of a fastener such that a rotation of the tamper-resistant fastener-head cover does not rotate the fastener;
means for accommodating a body of the fastener such that the tamper-resistant fastener-head cover cannot be pulled from the fastener along a length axis of the fastener;
means for securing a first portion of the tamper-resistant fastener-head cover to a second portion of the tamper-resistant fastener-head cover; and
means for modifying the tamper-resistant fastener-head cover to allow the first portion to rotate relative to the second portion effective to enable the first portion to be separated from the second portion.
